(19) United States
(12) Patent Application Publication
(10) Pub. No.: US 2026/0197255 A1
(43) Pub. Date: Jul. 9, 2026

(54) AUTOMATIC GENERATION AND VISUALIZATION OF ANALYSIS PATHS

(71) Applicant: INTERNATIONAL BUSINESS MACHINES CORPORATION, Armonk, NY (US)

(72) Inventors: Zijian Ding, College Park, MD (US); Michelle Brachman, Quincy, MA (US); Werner Geyer, Newton, MA (US)

(21) Appl. No.: 19/008,873

(22) Filed: Jan. 3, 2025

(51) Int. Cl. H04L 41/22; H04L 41/16

(52) U.S. Cl. CPC H04L 41/22; H04L 41/16

(57) ABSTRACT

Data and an intent of an entity relating to the data are obtained by at least one computing device. A set of analysis paths is automatically generated, by the at least one computing device, for the entity based, at least, on the data and the intent. The automatically generating uses an artificial intelligence application executing on the at least one computing device. The artificial intelligence application includes one or more models trained to generate the set of analysis paths. The set of analysis paths includes one or more analysis paths. A visualization of the set of analysis paths is created using the at least one computing device. The visualization of the set of analysis paths is displayed using the at least one computing device.

### BACKGROUND

One or more aspects relate, in general, to dynamic processing within a computing environment, and in particular, to improving such processing.

At times, there is an overload of information to digest. It may be difficult to think of all the ways of looking at the information, leading users of the information (e.g., workers) to miss potentially interesting ways of analyzing the information. Some users may use artificial intelligence systems, such as generative artificial intelligence systems, that support a linear layout to encourage linear thinking. However, this linear thinking is not appropriate for exploring analysis paths or hypotheses that diverge from the most common or obvious paths.

### SUMMARY

Shortcomings of the prior art are overcome, and additional advantages are provided through the provision of a computer-implemented method. The computer-implemented method includes obtaining, by at least one computing device, data and an intent of an entity relating to the data. A set of analysis paths is automatically generated, by the at least one computing device, for the entity based, at least, on the data and the intent. The automatically generating uses an artificial intelligence application executing on the at least one computing device. The artificial intelligence application includes one or more models trained to generate the set of analysis paths. The set of analysis paths includes one or more analysis paths. A visualization of the set of analysis paths is created using the at least one computing device. The visualization of the set of analysis paths is displayed using the at least one computing device.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 depicts one example of analysis paths generation and visualization code of FIG. 1, in accordance with one or more aspects of the present disclosure;

FIG. 3 depicts one example of a process to automatically generate and visualize a set of analysis paths, in accordance with one or more aspects of the present disclosure;

FIG. 4 pictorially depicts one example of technical details of one embodiment of automatically generating and visualizing a set of analysis paths, in accordance with one or more aspects of the present disclosure;

FIG. 5 depicts one example of a user interface used to interact with a visualization of the set of analysis paths, in accordance with one or more aspects of the present disclosure; and

FIG. 6 depicts one example of a machine learning training system used in accordance with one or more aspects of the present disclosure.

### DETAILED DESCRIPTION

In one or more aspects, a capability is provided to automatically generate analysis paths (e.g., hypotheses) using artificial intelligence and to visualize the generated analysis paths. The capability supports entities (e.g., users, other entities, etc.) in understanding complex data (e.g., datasets, databases, other data, etc.; information related to the data, such as, e.g., description of the data, metadata, relationships, etc.; and/or other complex data) by branching and visualizing generated analysis paths in multiple threads. This enables entities to further explore, iterate on and curate the analysis paths, e.g., employing one or more user interfaces, an interactive tool (e.g., a visualization tool), etc.

In one or more aspects, an initial set of analysis paths is automatically generated based on an entity uploading the entity's intent to understand data (e.g., one or more datasets, one or more databases, other data, etc.) that is input to the system. The system uses, in one example, artificial intelligence, at least, to automatically generate the initial set of analysis paths. The artificial intelligence used includes one or more types, fields and/or strategies, such as machine learning (e.g., uses data and algorithms to imitate the way humans learn) and/or generative artificial intelligence (e.g., one or more deep-learning models capable of generating content based on data on which they were trained), as examples. The artificial intelligence executes one or models (e.g., programs that apply algorithms(s) to data to learn, e.g., recognize patterns, make predictions and/or make decisions without human intervention). As used herein, an artificial intelligence application includes one or more models (e.g., large language models, foundation models and/or other models) trained to generate and visualize a set of analysis paths. For instance, the artificial intelligence application executes the one or more models to generate and visualize the set of analysis paths. As examples, one model may be trained for all aspects of generating and visualizing a set of analysis paths (and/or perform other aspects) or various models are used for various aspects. Further, the artificial intelligence application may be one or more artificial intelligence applications executing one or more models. Many examples are possible.

In one example, the artificial intelligence application executes on at least one computing device and includes one or more trained artificial intelligence models to generate the initial set of analysis paths (and/or other analysis paths), visualize the initial set of analysis paths (and/or other analysis paths) and/or revise the initial set of analysis paths (and/or other analysis paths) based on interaction signals received from the entity. Other examples are possible.

In one or more aspects, the initial set of analysis paths, which includes one or more analysis paths, is branched and visualized in a visualization. In one example, the visualization includes an interactive node-link diagram. As an example, the generated analysis paths are branched and visualized in an interactive node-link diagram, which is computer-generated (e.g., by one or more computing devices) and presented with preliminary visualization results and related work. Entities can iterate on specific analysis paths by selecting individual nodes of the interactive node-link diagram to provide guidance to generate more detailed sub-analysis paths. In one example, the interactive node-link diagram highlights the current exploration path (i.e., the current analysis path being explored) while de-emphasizing alternative branches to provide a clear visual guide. Other possibilities also exist.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of generating and/or visualizing analysis paths and/or performing one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

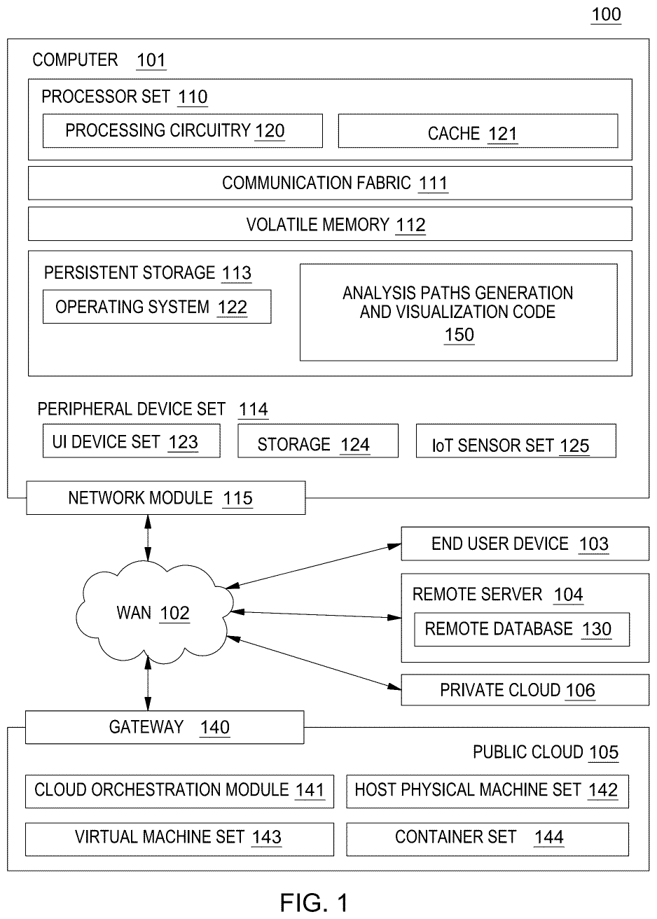

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as analysis paths generation and visualization code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

In one example, to automatically generate and visualize analysis paths, analysis paths generation and visualization code (e.g., analysis paths generation and visualization code 150) is used, in accordance with one or more aspects of the present disclosure. Analysis paths generation and visualization code (e.g., analysis paths generation and visualization code 150) includes code or instructions used to automatically generate, visualize and/or revise analysis paths, in accordance with one or more aspects of the present disclosure. The code is, e.g., computer-readable program code (e.g., instructions) in computer-readable media, e.g., storage (persistent storage 113, cache 121, storage 124, other storage, as examples). The computer-readable media may be part of a computer program product and the computer-readable program code may be executed by and/or using one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computing devices, computers, servers, processors, nodes and/or processing circuitry may be used to execute the code and/or portions thereof. Many examples are possible.

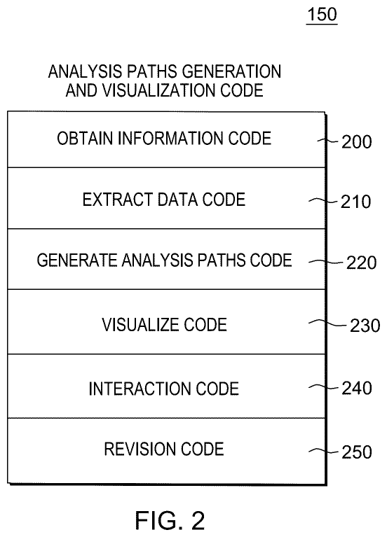

One example of analysis paths generation and visualization code 150 is described with reference to FIG. 2. In one example, analysis paths generation and visualization code 150 includes obtain information code 200 to be used to obtain information, such as input data (e.g., data, datasets, databases, etc.) and intent of an entity (e.g., request to understand the data); extract data code 210 to be used to extract additional data, such as information related to the input data; generate analysis paths code 220 to be used to generate a set of analysis paths that includes one or more analysis paths; visualize code 230 to be used to provide (e.g., create and/or display) visualization of the one or more analysis paths; interaction code 240 to be used to receive signals (e.g., indications, etc.) based on interacting with the visualization; and revision code 250 to be used to revise the visualization, the set of analysis paths and/or one or more of the analysis paths. Additional, less and/or other code may be provided and/or used in one or more aspects of the present disclosure.

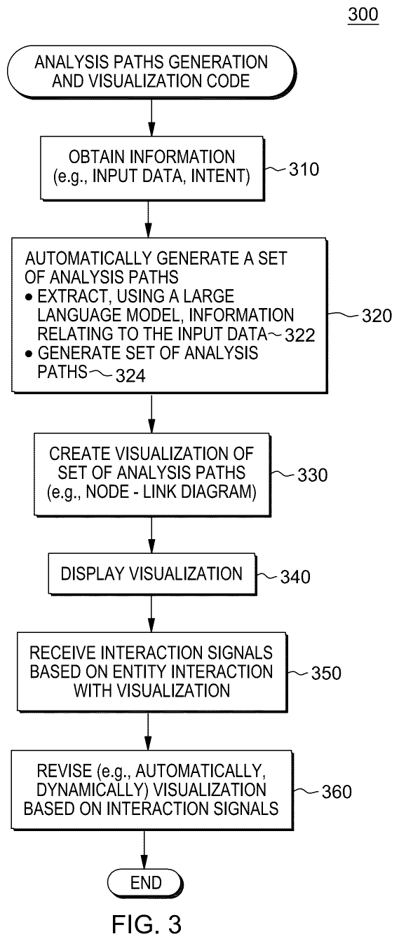

In one example, analysis paths generation and visualization code 150 includes code (e.g., code 200-250) that is used to automatically generate and visualize a set of analysis paths, as further described in one example with reference to FIG. 3. FIG. 3 depicts one example of a process 300 that is executed by one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computing devices, computers, servers, processors, nodes and/or processing circuitry may be used to execute the process and/or portions thereof. Various options are possible.

Referring to FIG. 3, in one example, process 300 obtains 310 (e.g., using obtain information code 200) information from one or more entities. The information includes, for example, input data (e.g., data, one or more datasets, one or more databases, etc.) related to a topic, as well as intent of an entity to learn more about the topic. The topic may be of many different topics, including, but not limited to, failure of a system, such as a computer system, mechanical system, electrical system, etc.; implementation and/or construction of a product (e.g., a software product, hardware product, etc.); workforce-related information, such as worker wage information for different groups of workers; etc. Many example topics are able to be explored, in accordance with one or more aspects of the present disclosure.

As an example, the information is input via a user (or one or more users; one or more other entities). The user may, as examples, use one or more prompts to input the information and/or store the information in storage accessible for retrieval. If stored, access information may be provided. Many alternatives and examples are possible. A computing device that is executing process 300 receives, in one example, the information over one or more networks. As another example, the computing device accesses the storage to obtain the information. Other examples are possible.

Based on, at least, the obtained input data and the intent, process 300 automatically generates 320 (e.g., using generate analysis paths code 220) a set of analysis paths to be visually displayed and explored by the user(s) (and/or other entities). As an example, process 300 uses (e.g., via executing an artificial intelligence application) one or more artificial intelligence models (e.g., one or more generative artificial intelligence models) to analyze the input data (e.g., data, datasets, databases, etc.) based on the intent and generate a set of potential analysis paths. In one example, process 300 uses a type of generative artificial intelligence model, referred to as a large language model (LLM), to extract 322 (e.g., using extract data code 210) information about the input data (e.g., semantically meaningful column names and/or metadata). A large language model can generate and recognize text and is trained on large amounts of data. It is built using machine learning, such as a transformer model.

Based on the extracted information and user inputs (e.g., data and/or intent), the large language model is used to generate 324 a set of potential analysis paths. For instance, the large language model (and/or other artificial intelligence models) is trained to generate analysis paths based on data and/or information relating to the intent. Process 300 generates one or more analysis paths based on what it has been trained and other data and/or information it has obtained. In one example, process 300 checks the strength of the relationships between variables based on the underlying data.

Process 300 creates 330 (e.g., using visualize code 230) a visualization of the set of analysis paths. The visualization may be, for instance, a node-link diagram or other visualization. In one example, process 300 displays 340 (e.g., using visualize code 230) the visualization. For instance, it displays the set of analysis paths (e.g., large language model-generated analysis paths) in a node-link diagram, in which each node represents select information about the topic and a pathway from an initial node to an ending node is an analysis path. In one example, process 300 further displays additional information about the reasoning behind the analysis paths, which is generated using, e.g., the artificial intelligence application.

Process 300 receives 350 (e.g., using interaction code 240), in one example, one or more interaction signals (e.g., indications, etc.) based on the entity interacting with the visualization. The entity interacts with the visualization by, e.g., performing one or more actions, including, but not limited to, comparing analysis paths, regenerating one or more analysis paths and/or exploring one or more analysis paths. The entity can explore analysis paths through actions, such as: view the potential analysis paths all at once, view additional details (preliminary analysis of the analysis paths, related work of the analysis paths) about individual analysis paths, view additional exogenous information retrieved from one or more exogenous sources relating to the input data, request further information based on the information extracted from the input data based on the intent and/or request further potential analysis paths based on one or more existing analysis paths, etc. The visualization enables the user to view paths currently explored, as well as explore new paths. In one example, a user interface (and/or interaction tool, etc.) may allow users to store/save analysis paths for further review; use, remove analysis paths; make connections between analysis paths; and/or manually add analysis paths. In one example, a user may change a threshold for the strength of relationships to filter out an analysis path being shown. Many examples are possible.

Process 300 revises 360 (e.g., automatically, dynamically; e.g., using revision code 250) the visualization and/or one or more analysis paths based on the interaction signals. For instance, based on one or more actions performed on the visualization by the entity, process 300 using, e.g., the artificial intelligence application, regenerates the set of analysis paths, in which one or more analysis paths (and/or sub-analysis paths) are added to the set of analysis paths, one or more analysis paths (and/or sub-analysis paths) are removed and/or one or more analysis paths (and/or sub-analysis paths) are revised, etc. Many variations are possible.

Further, in one example, based on the revisions and/or interactions with the visualization, one or more of the artificial intelligence models are retrained and further learn to provide improved analysis paths on a next iteration of the process.

In one example, process 300 (and/or a tool including and/or using process 300) uses one or more artificial intelligence models with chains of prompts. One example of a prompt design for generating initial analysis paths and iterating through new analysis path branches includes, for instance:
Prompt for Initial Hypothesis Generationmessages=[
{“role”: “system”, “content”: SYSTEM_INSTRUCTIONS},
{“role”: “assistant”,
“content”:
f“{USER_PROMPT}\n\n {FORMAT_INSTRUCTIONS} \n\n. The generated {n} goals are: \n
”}]SYSTEM_INSTRUCTIONS:
You are an experienced data analyst who can generate a given number of insightful Hypotheses about data, when given a summary of the data, and a specified persona. The VISUALIZATIONS YOU RECOMMEND ARE TO FOLLOW VISUALIZATION BEST PRACTICES (e.g., are to use bar charts instead of pie charts for comparing quantities) AND BE MEANINGFUL (e.g., plot longitude and latitude on maps where appropriate). They also are to be relevant to the specified persona. Each goal is to include a hypothesis with a title (in [], and the title does not need to include the target variable, just include the new variable in the hypothesis), a visualization (THE VISUALIZATION IS TO REFERENCE THE EXACT COLUMN FIELDS FROM THE SUMMARY), and a rationale (JUSTIFICATION FOR WHICH dataset FIELDS ARE USED and what will be learned from the visualization).
USER_PROMPT:
The number of Hypothesis to generate is 5. The goals are to be based on the data summary below, {data summary}. The generated Hypothesis SHOULD BE FOCUSED ON THE INTERESTS AND PERSPECTIVE of a {persona. persona} persona, who is interested in complex, insightful goals about the data.
FORMAT_INSTRUCTIONS:
THE OUTPUT IS TO BE A CODE SNIPPET OF A VALID LIST OF JSON OBJECTS. IT IS TO USE THE FOLLOWING FORMAT:
[
{“index”: 0, “hypothesis”: “[new variable X]: Y is highly correlated to X.”,
“visualization”: “scatterplot of X and Y”,
“rationale”: “This tells about ”} . . .
]
THE OUTPUT IS TO ONLY USE THE JSON FORMAT ABOVE. New Hypothesis Branch Generation (Hypothesis Iteration) Based on the hypothesis {selected hypothesis} [and the user input {user input}] (optional, if there is user input to guide new hypothesis generation), generate 3 new and more insightful hypotheses based on the given hypothesis. Format the output as a JSON array with the following structure for each hypothesis:
{
“title”: “short new variable X (no more than two words)”,
“hypothesis”: “There is a . . . ”,
“relatedWork”: “Previous studies have shown that . . . ”,
“visualization”: “Description of visualization idea”,
“rationale”: “Rationale for the visualization”.

Other examples are possible.

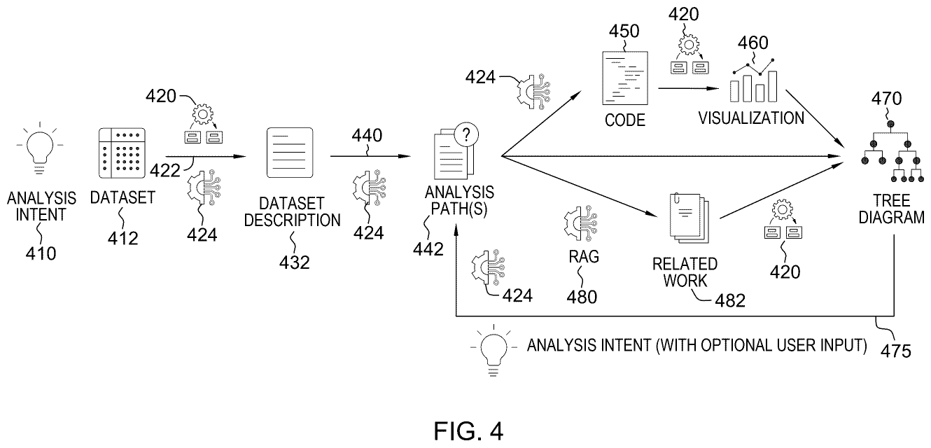

One example of technical details of various aspects of the present disclosure is pictorially depicted in FIG. 4. In one example, analysis intent 410 (e.g., an entity's intent) and data, such as one or more datasets 412, are input to a processing unit 420 (e.g., a computing device) that performs processing 422 to automatically generate a set of analysis paths (e.g., one or more analysis paths). The processing includes, for instance, using one or more artificial intelligence models 424 (e.g., one or more large language models) to extract information, such as a dataset description 432 and generate 440 an initial set of analysis paths 442.

Analysis paths of initial set of analysis paths 442 are branched using, e.g., one or more artificial intelligence models 424 (e.g., one or more large language models) to provide one or more code snippets 450 (e.g., JSON (JavaScript Object Notation) objects) and visualized 460 using a processing unit 420 (e.g., a computing device) into a visualization, such as an interactive computer-generated node-link diagram 470 (also referred to as a tree diagram). In one or more aspects, the entity iterates 475 on specific analysis paths by, e.g., selecting individual nodes and providing guidance to generate more detailed sub-analysis paths.

Further, in one or more aspects, based on the one or more analysis paths of initial set of analysis paths 442, retrieval-augmented generation (RAG) 480 is used to improve the results of the large language models (or other artificial intelligence) used to generate the set of analysis paths by employing information retrieval systems to retrieve more accurate and relevant text 482 and provide, e.g., using a processing unit 420 (e.g., a computing device) more accurate results, which are included in the visualization (e.g., added to the visualization, used to revise the visualization, used to remove from the visualization, etc.).

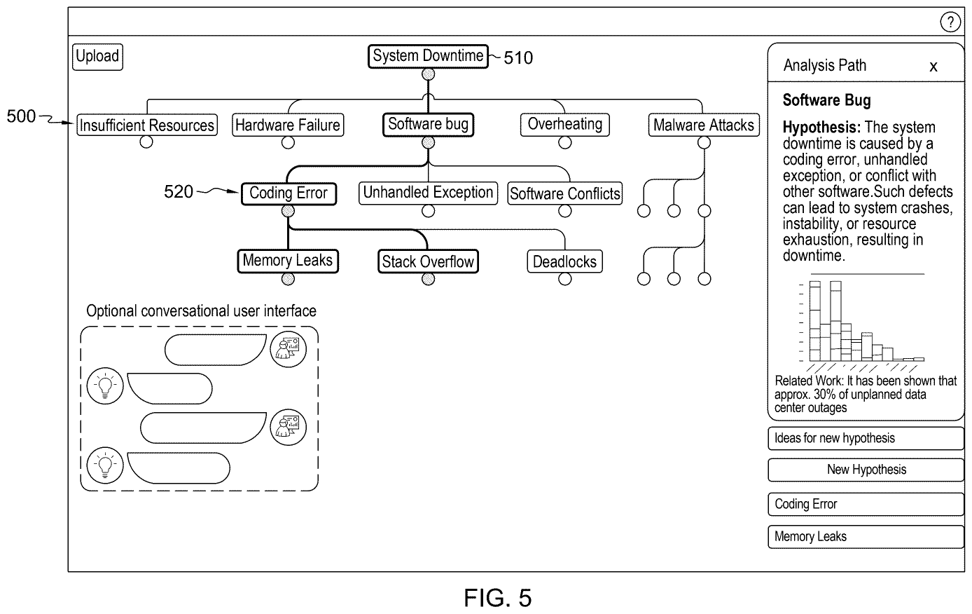

One example of a user interface used to iterate on one or more analysis paths is depicted in FIG. 5. In one or more aspects, an initial set of analysis paths is generated based on input data and an intent of an entity (e.g., a user). For instance, an initial set of analysis paths 500 is generated based on an entity's intent to understand system downtime 510. In one example, the number of initial analysis paths is, e.g., five (5) and the goals are based, e.g., on the below data summary (e.g., {data summary}). The generated initial analysis paths are to be focused on the interests and perspective of, e.g., a {persona. persona} persona, who is interested in complex, insightful goals about the data (e.g., system downtime). The output is, e.g., a code snippet of a valid list of, e.g., JSON objects. In one example, the following format is used:
“[
{“index”: 0, “analysis path”: “[new variable X]: Y is highly correlated to X.”, “visualization”: “scatterplot of X and Y”, “rationale”: “this tells about”}. . .
]
. . . .”
Further, in one example, based on the analysis paths [obtained from the user interaction selection], a prompt is provided to generate, e.g., three (3) new and more insightful analysis paths (e.g., analysis paths 520) based on the given analysis paths. In one example, the output is formatted as, e.g., a JSON array with the following structure for each analysis path:
   {‘title”: “short new variable X (no more than two words)”, “hypothesis”: “There is a . . . ”, “relatedWork”: “Previous studies have shown that . . . ”, “visualization”: “Description of visualization idea”, “rationale”: “Rationale for the visualization”};
In one or more aspects, instead of general text generation from a large language model, analysis path (e.g., hypothesis) generation in data analysis is provided that supports functions relevant to analysis paths, such as generating preliminary results and retrieving related work. In one or more aspects, the context is data analysis instead of design, so a tool (e.g., process, technique, implementation, system, capability, user interface, etc.) of one or more aspects of the present disclosure focuses on path analysis generation as opposed to problem/solution generation. A visualization technique of one or more aspects uses a vertical position to represent the depth of the analysis path exploration.

In one or more aspects, a tool is provided for analysis path generation in data analysis instead of complex information tasks, in general. In one or more aspects, the tool uses, e.g., highlighting and fading out, instead of hierarchical views to emphasize a different information thread. The tool is designed to support a user (or other entity) in exploring multiple analysis paths based on one or more datasets. Users may explore and iterate on analysis paths through graphical representation and interaction. Users are able to explore a variety of analysis paths through a graphical and textual user interface, rather than ranking and filtering to a particular suggested analysis path. The user may interact with the analysis path and generate new analysis paths.

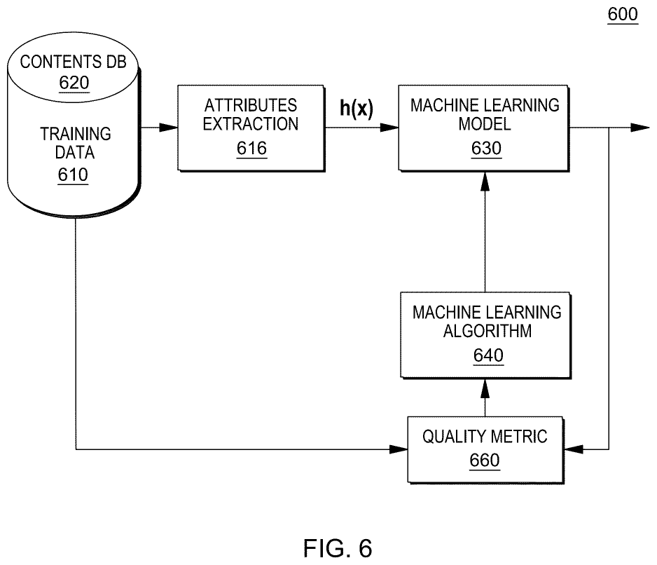

In one or more aspects, artificial intelligence including machine learning is used. One example of a machine learning training system is described with reference to FIG. 6. In one or more aspects, a machine learning training system 600 may be utilized to perform cognitive analyses of various inputs, including input data, data from one or more sources (e.g., exogenous sources), repositories, data structures and/or other data. The data may include data relating to a particular topic and/or information about the data (e.g., metadata), etc. Training data utilized to train a model in one or more embodiments of the present disclosure includes, for instance, data that pertains to one or more topics and/or events, such as natural language processing data, record data being processed; data that pertains to analysis paths; data obtained from exogenous sources (e.g., databases, etc.); actions that have been taken; available resources; and/or intent of an entity; etc. The program code in embodiments of the present disclosure performs a cognitive analysis to generate one or more training data structures, including algorithms utilized by the program code to predict states of a given event (e.g., generation, visualization and/or revision of analysis paths). Machine learning (ML) solves problems that are not solved with numerical means alone. In this ML-based example, program code extracts various attributes from ML training data 610 (e.g., historical attribute data collected from various data sources relevant to the event (e.g., generation, visualization and/or revision of analysis paths)), which may be resident in one or more databases 620 comprising event or task-related data and general data. Attributes 615 are utilized to develop a predictor function, h(x), also referred to as a machine learning hypothesis, which the program code utilizes as a machine learning model 630.

In identifying various event states, features, attribute similarities, constraints and/or behaviors indicative of states in the ML training data 610, the program code can utilize various techniques to identify attributes in an embodiment of the present disclosure. Embodiments of the present disclosure utilize varying techniques to select attributes (data attributes, analysis path attributes, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 640 to train the machine learning model 630 (e.g., the algorithms utilized by the program code), including providing weights for the conclusions, so that the program code can train the predictor functions that comprise the machine learning model 630. The conclusions may be evaluated by a quality metric 650. By selecting a diverse set of ML training data 610, the program code trains the machine learning model 630 to identify and weight various attributes (e.g., data attributes, features, patterns, constraints, distributions, etc.) that correlate to various states of an event.

The model generated by the program code is self-learning as the program code updates the model based on active event feedback, as well as from the feedback received from data related to the event. For example, when the program code determines that there is a constraint, event, similarity or pattern (e.g., data attribute, record attribute similarity, query pattern, data distribution, search terms distribution, etc.) that was not previously predicted by the model, the program code utilizes a learning agent to update the model to reflect the state of the event, in order to improve predictions in the future (e.g., improve the generation and visualization of the analysis paths). Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on one or more processors, utilizes an existing cognitive analysis tool or agent (now known or later developed) to tune the model, based on data obtained from one or more data sources. In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, the program code utilizes a neural network to analyze event-related data to generate the model utilized to predict the state of a given event at a given time. Neural networks are biologically inspired programming paradigms, which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools. They are usually used to model complex relationships between inputs and outputs or to identify patterns (or similarities) in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in multiple source processing, which the program code in one or more embodiments accomplishes when obtaining data and generating a model for predicting states of a given event.

As described herein, in one or more aspects, visual large language model-assisted analysis path generation and exploration are provided to support data analysis. In one or more aspects, users are able to explore analysis paths that they may not have thought to, based on connections made in the data by large language models that are trained on more information than a user could remember/learn. Even a user using a large language model to generate analysis paths would not be able to view and explore an analysis path as quickly as they could with one or more aspects of the present disclosure.

The tool of one or more aspects supports data understanding and analysis path generation for users without requiring technical knowledge. One or more aspects are used for numerical data, as well as textual data.

One or more aspects enable graphical visualization and exploration of artificial intelligence generated analysis paths based on intent (e.g., a high-level intent). One or more aspects take in a set of information or data, such as, e.g., one or more numerical datasets, textual datasets, various information sources from a database or search engine, etc. ; process the information using the high level intent to generate potential analysis paths for exploration; visualizes the artificial intelligence generated analysis paths to enable comparison, exploration and/or regeneration through interaction with the visualization; optionally enable the user (or other entity) to collect and organize the potential analysis paths, such as through favorites, saving, creating reports; optionally, provide a chat interaction that enables the user to explore the analysis paths through natural language in conjunction with the user interface; and/or optionally, provide further assistance in performing analyses for analysis paths, such as through generated code, integration with analysis notebooks, etc.

In one or more aspects, to generate analysis paths, the information is obtained and potential analysis paths are determined, using, e.g., a large language model with prompts that leverage the information to generate analysis paths. Retrieval-augmented generation is employed to bring in other sources of information, against systems that make plans, etc. New analysis paths are generated based on user selection and/or automatically based on tool selections.

One or more aspects support users in understanding complex datasets by generating and visualizing multiple possible analysis paths and enabling the user to explore and interact. Generative artificial intelligence support is provided to users for the phase of understanding and exploration of data or information to support them in exploring and selecting analysis paths to explore.

In one or more aspects, a capability for generating analysis paths (e.g., hypotheses) regarding a dataset (e.g., and/or other data) is provided. The method includes receiving, from one or more entities (e.g., users), a high-level intent; extracting, by artificial intelligence (e.g., a large language model), dataset information from the dataset based on the high-level intent; retrieving, using one or more tools and/or advanced programming interfaces, additional information from one or more external sources based on the dataset information; generating, by the large language model, one or more analysis paths based on the dataset information and/or the additional information; and/or creating a visualization tool that displays the one or more analysis paths to the one or more users.

In one or more aspects, the visualization tool enables the one or more users to interact with the visualization tool through a plurality of actions selected from a list including comparing, exploring, and regenerating the one or more analysis paths.

In one or more aspects, the exploring includes one or more actions selected from a list including viewing the additional information, displaying additional details about the one or more analysis paths, and/or requesting further dataset information based on the dataset information, etc.

In one or more aspects, the visualization tool enables the one or more users to collect and/or organize the one or more analysis paths through one or more actions selected from a list including favoriting, storing, saving, and/or creating a report, etc.

In one or more aspects, the visualization tool includes a chat functionality that enables the one or more users to interface with the visualization tool through natural language interactions.

In one or more aspects, the technique further includes assembling, by the large language model, a plurality of reasoning for each of the one or more potential analysis paths, and the visualization tool further displays the plurality of reasoning to the one or more users.

In one or more aspects, the visualization tool enables the one or more users to view one or more analysis paths already explored and/or one or more new analysis paths.

In one or more aspects, the technique further includes analyzing the one or more analysis paths using generated code and/or integration with one or more analysis notebooks.

In one or more aspects, the visualization tool further displays a description of the analysis paths, one or more charts of the dataset information and/or the additional information, and/or a plurality of context associated with the one or more analysis paths.

One or more aspects are tied to computer technology and facilitate processing within a computer, improving performance thereof. In one or more aspects, technical fields of computing and artificial intelligence are improved. For instance, the understanding of data is improved, and the automatic generation of potential analyses paths is provided. One or more aspects assist experts in rapidly exploring data-related problems; and balance diversity, manageability, and required time and computational resources as follows, in one example:
Diversity: Generate, e.g., three to five solutions at a time, allowing the problem to be addressed from different angles and stimulating more thinking from experts.
Manageability: Provide multiple options without having too many, making it easy to compare and choose.
Required Time and Computational Resources: Generating, e.g., three solutions each time ensures that the user's waiting time is not too long and does not require excessive computational resources. (Different numbers than 3 and/or 5 may be selected, in other examples.)

In one or more aspects, a visualization of generated potential analysis paths is combined with the capabilities to view more information about the generated analysis paths, further investigate potential analysis paths using the interactive visualization and keep track of the user's analysis path through the work. A capability is provided to understand data and decide on potential analysis paths to pursue.

In one or more aspects, a large language model is used to generate potential analysis paths to help a user decide which part of the data and analysis on which to focus. Interactive techniques of interacting with the large language model-generated content are provided. An interactive tool or system is provided to enable exploration of potential analysis paths for a dataset.

The computing environments described herein are only examples of computing environments that can be used. One or more aspects of the present disclosure may be used with many types of environments. Each computing environment is capable of being configured to include and/or use one or more aspects of the present disclosure. For instance, each may be configured to provide analysis paths generation, visualization and/or revision and/or to perform one or more other aspects of the present disclosure.

In addition to the above, one or more aspects may be provided, offered, deployed, managed, serviced, etc. by a service manager who offers management of customer environments. For instance, the service manager can create, maintain, support, etc. computer code and/or a computer infrastructure that performs one or more aspects for one or more customers. In return, the service manager may receive payment from the customer under a subscription and/or fee agreement, as examples. Additionally, or alternatively, the service manager may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other data and/or models may be used. Further, a different number of analysis paths may be initially generated and/or further generated. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
obtaining, by at least one computing device, data and an intent of an entity relating to the data;
automatically generating, by the at least one computing device, a set of analysis paths for the entity based, at least, on the data and the intent, the automatically generating using an artificial intelligence application executing on the at least one computing device, the artificial intelligence application including one or more models trained to generate the set of analysis paths, the set of analysis paths including one or more analysis paths;
creating, using the at least one computing device, a visualization of the set of analysis paths; and
displaying, using the at least one computing device, the visualization of the set of analysis paths.

2. The computer-implemented method of claim 1, further comprising:
receiving, based on interactions of the entity with the visualization of the set of analysis paths, interaction signals of the visualization; and
automatically revising the visualization based on the interaction signals to further define the set of analysis paths.

3. The computer-implemented method of claim 2, wherein the interactions include one or more actions selected from a group of actions comprising comparing, exploring and regenerating at least one analysis path of the set of analysis paths.

4. The computer-implemented method of claim 3, wherein the exploring includes performing at least one action selected from a set of actions comprising viewing additional exogenous information relating to the data and retrieved from exogenous sources, displaying additional details relating to at least one analysis path of the set of analysis paths, and requesting further information based on information extracted from the data based on the intent.

5. The computer-implemented method of claim 1, wherein the visualization is a computer-generated node-link diagram in which the one or more analysis paths are represented as nodes in the computer-generated node-link diagram.

6. The computer-implemented method of claim 1, wherein the automatically generating the set of analysis paths includes:
extracting, using the artificial intelligence application, information from the data based on the intent; and
using the information in the automatically generating the set of analysis paths.

7. The computer-implemented method of claim 6, wherein the automatically generating the set of analysis paths further includes:
retrieving additional information from one or more exogenous sources; and
using the additional information in the automatically generating the set of analysis paths.

8. The computer-implemented method of claim 1, wherein at least one of the creating and the displaying is performed using a visualization tool, and wherein the visualization tool facilitates collection and organization of the set of analysis paths.

9. The computer-implemented method of claim 1, wherein at least one of the creating and the displaying is performed using a visualization tool, and wherein the visualization tool facilitates storing the set of analysis paths.

10. The computer-implemented method of claim 1, wherein at least one of the creating and the displaying is performed using a visualization tool, and wherein the visualization tool provides a chat interaction to the entity to provide an interface with the visualization tool through natural language processing.

11. The computer-implemented method of claim 1, further comprising generating, by the artificial intelligence application, reasoning for the set of analysis paths, and wherein the displaying the visualization includes displaying the reasoning.

12. The computer-implemented method of claim 1, wherein the visualization facilitates viewing by the entity one or more analysis paths already explored and one or more new analysis paths.

13. A computer program product comprising:
a set of one or more computer-readable storage media; and
program instructions, collectively stored in the set of one or more computer-readable storage media, for causing at least one computing device to perform computer operations including:
obtaining, by at least one computing device, data and an intent of an entity relating to the data;
automatically generating, by the at least one computing device, a set of analysis paths for the entity based, at least, on the data and the intent, the automatically generating using an artificial intelligence application executing on the at least one computing device, the artificial intelligence application including one or more models trained to generate the set of analysis paths, the set of analysis paths including one or more analysis paths;
creating, using the at least one computing device, a visualization of the set of analysis paths; and
displaying, using the at least one computing device, the visualization of the set of analysis paths.

14. The computer program product of claim 13, wherein the computer operations further include:
receiving, based on interactions of the entity with the visualization of the set of analysis paths, interaction signals of the visualization; and
automatically revising the visualization based on the interaction signals to further define the set of analysis paths.

15. The computer program product of claim 13, wherein the visualization is a computer-generated node-link diagram in which the one or more analysis paths are represented as nodes in the computer-generated node-link diagram.

16. The computer program product of claim 13, wherein the automatically generating the set of analysis paths includes:
extracting, using the artificial intelligence application, information from the data based on the intent; and
using the information in the automatically generating the set of analysis paths.

17. A computer system comprising:
at least one computing device;
a set of one or more computer-readable storage media; and
program instructions, collectively stored in the set of one or more computer-readable storage media, for causing the at least one computing device to perform computer operations including:
obtaining, by at least one computing device, data and an intent of an entity relating to the data;
automatically generating, by the at least one computing device, a set of analysis paths for the entity based, at least, on the data and the intent, the automatically generating using an artificial intelligence application executing on the at least one computing device, the artificial intelligence application including one or more models trained to generate the set of analysis paths, the set of analysis paths including one or more analysis paths;
creating, using the at least one computing device, a visualization of the set of analysis paths; and
displaying, using the at least one computing device, the visualization of the set of analysis paths.

18. The computer system of claim 17, wherein the computer operations further include:
receiving, based on interactions of the entity with the visualization of the set of analysis paths, interaction signals of the visualization; and
automatically revising the visualization based on the interaction signals to further define the set of analysis paths.

19. The computer system of claim 17, wherein the visualization is a computer-generated node-link diagram in which the one or more analysis paths are represented as nodes in the computer-generated node-link diagram.

20. The computer system of claim 17, wherein the automatically generating the set of analysis paths includes:
extracting, using the artificial intelligence application, information from the data based on the intent; and
using the information in the automatically generating the set of analysis paths.
